(19) United States
(12) Patent Application Publication
(10) Pub. No.: US 2023/0119785 A1
(43) Pub. Date: Apr. 20, 2023

(54) SYSTEM AND METHOD FOR PERSONALIZING A PRODUCT CONTENT

(71) Applicant: FLIPKART INTERNET PRIVATE LIMITED, Bengaluru (IN)

(72) Inventor: Surbhi Mathur, Bangalore (IN)

(73) Assignee: FLIPKART INTERNET PRIVATE LIMITED, Bengaluru (IN)

(21) Appl. No.: 17/969,288

(22) Filed: Oct. 19, 2022

(30) Foreign Application Priority Data
Oct. 20, 2021 (IN) 202141047628

(51) Int. Cl. G06Q 30/06; H04L 67/306

(52) U.S. Cl. CPC G06Q 30/0621; G06Q 30/0625; H04L 67/306

(57) ABSTRACT

A system and method for personalizing one or more product contents. The method encompasses detecting, the one or more product contents on a digital platform in response to a product search query. The method thereafter comprises detecting, at least one of one or more objects and one or more attributes for each of the one or more product contents. Further the method encompasses extracting, at least one target portion from each of the one or more product contents based on the at least one of the detected one or more objects and the detected one or more attributes. The method thereafter comprises augmenting, each of the one or more product contents with the corresponding at least one target portion to personalize the one or more product contents.

### RELATED APPLICATION

This application claims priority under 35 U.S.C. § 119 to Indian Patent Application No. 202141047628, filed on Oct. 20, 2021, the entire contents of which are incorporated herein by reference.

### TECHNICAL FIELD

The present invention generally relates to dynamic content creation and more particularly to systems and methods for personalizing product content.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Electronic devices now-a-days are capable of providing various facilities to users. For instance, the users can avail services in real time via accessing various digital platforms on the electronic devices. In order to enhance an experience of the users with the digital platforms, a number of solutions have been developed over a period to time. One of such solution is related to providing over the digital platforms various details related to various products and/or services. Therefore, the users can easily access required details from the details available with the digital platforms. For instance, in order to help the users in better selection of products, an e-commerce platform provides its users details of each product available on said e-commerce platform.

Although, the currently known solutions are capable of providing various details at the digital platforms, but there are a number of limitations of these solutions. For instance, on all e-commerce platforms, though the products shown to each user are ranked according to a search query of such user and/or a user profile of such user, but content(s) shown for those products are static and are not personalized. The content(s) displayed like product images, product videos and product description etc. are ordinarily the content(s) uploaded by a seller of the product.

Furthermore, to provide details of contents available on the digital platforms, some of the known solutions provide a zoomed-in/enlarged view of a part of an image/content on hovering a cursor on said part. However, these solutions also have a number of limitations. For instance, in order to zoom a part of an image, the users explicitly point to or select a part of the image he/she wants to see a zoomed version of, therefore these solutions fail to automatically identify and enhance a relevant part of an image to further provide personalized contents to the users. Also, for most e-commerce platforms the zooming on hover solution is implemented for product pages only and is not convenient for search pages where a thumbnail view of product image(s)/video(s) is shown. Furthermore, the currently known zooming solutions encompasses use of scaling that is implemented using interpolation methods like bilinear, nearest-neighbour etc., which could lead to pixelation in cases where the image quality is poor, or the pattern is very detailed.

Also, in some other known solutions, an application of content aware cropping/expansion is disclosed to resize an image or to resize a selected object. In such solutions, an image/object may be selected using an approximate bounding box. More particularly, in said solutions an input may be received indicating a lowest priority edge or corner of the image or object to be resized (e.g., using a drag operation). Thereafter, respective energy values for some pixels of the image and/or of the object to be resized may be weighted based on their distance from the lowest priority edge/corner and/or on a cropping or expansion graph. Further, in such known solutions relative costs may be determined for seams of the image dependent on energy values. Low cost seams may be removed or replicated in different portions of the image and/or the object to modify the image. Also, in such known solutions, a selected object may be resized using interpolated scaling and patched over the modified image. Such currently known solutions also have a number of limitations such as selection of an object/image of interest based on a user input, therefore these solutions fails to automatically identify and enhance an object/image of interest in order to further provide personalized contents to the users. Also, such solutions fail to disclose augmenting of an image with an additional information/content and in such known solutions a content of the image also remains semantically similar.

Therefore, there are a number of limitations of the current solutions and there is a need in the art to provide a method and system for personalizing a product content.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for personalizing a product content through product image enrichment using selective focus. Also, an object of the present invention is to provide an automatic detection of a most relevant part of a product content (a product content may be an image or a video of a product) based on a user search query and/or user profile based features like browsing pattern etc. Another object of the present invention is to artificially generate a high-resolution version of an automatically detected most relevant part of an image/video and augment the image/video with it. Further an object of the present invention is to enrich an information at least in a product thumbnail view present on a search and browse page to further provide better browsing and user experience.

Furthermore, in order to achieve the aforementioned objectives, the present invention provides a method and system for personalizing a product content.

A first aspect of the present invention relates to the method for personalizing one or more product contents. The method encompasses detecting, by a processing unit, the one or more product contents on a digital platform in response to a product search query initiated by a user of the digital platform. The method thereafter comprises detecting, by the processing unit, at least one of one or more objects and one or more attributes for each of the one or more product contents, wherein the at least one of the one or more objects and the one or more attributes are detected based on at least one of: the product search query, a user profile of the user, and a pre-defined list of at least one of a set of objects and a set of attributes. Further the method encompasses extracting, by an extraction unit, at least one target portion from each of the one or more product contents based on the at least one of the detected one or more objects and the detected one or more attributes. The method thereafter comprises augmenting, by the processing unit, each of the one or more product contents with the corresponding at least one target portion to personalize the one or more product contents.

Another aspect of the present invention relates to a system for personalizing one or more product contents. The system comprises a processing unit, configured to detect, the one or more product contents on a digital platform in response to a product search query initiated by a user of the digital platform. The processing unit is further configured to detect, at least one of one or more objects and one or more attributes for each of the one or more product contents, wherein the at least one of the one or more objects and the one or more attributes are detected based on at least one of: the product search query, a user profile of the user, and a pre-defined list of at least one of a set of objects and a set of attributes. Further the system comprises an extraction unit, configured to extract, at least one target portion from each of the one or more product contents based on the at least one of the detected one or more objects and the detected one or more attributes. Also, the processing unit is further configured to augment each of the one or more product contents with the corresponding at least one target portion to personalize the one or more product contents.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for personalizing one or more product contents, in accordance with exemplary embodiments of the present invention.

FIG. 2 illustrates an exemplary product content, in accordance with exemplary embodiments of the present invention.

FIG. 3 illustrates an exemplary scenario for extraction of at least one target portion from a product content, in accordance with the exemplary embodiments of the present invention.

FIG. 4 illustrates an exemplary product content augmented with a high resolution variant of a corresponding target portion, in accordance with the exemplary embodiments of the present invention.

FIG. 5 illustrates an exemplary method flow diagram [500], for personalizing one or more product contents, in accordance with exemplary embodiments of the present invention.

FIG. 6 illustrates an exemplary product content, in accordance with exemplary embodiments of the present invention.

FIG. 7 illustrates an exemplary product content augmented with a high resolution variant of a corresponding target portion, in accordance with the exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from an identification unit, a processing unit, an extraction unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies have many limitations and in order to overcome at least some of the limitations of the prior known solutions, the present disclosure provides a solution for personalizing one or more product contents. Each product content may be one of an image of a product and a video of a product. In order to personalize the one or more product contents, the present invention encompasses augmenting the one or more product contents with a high resolution variant of at least a corresponding most relevant part of the one or more product contents. A most relevant part of a product content is identified based on a user search query initiated on a digital platform for said product content and a profile of a user who initiated the user search query, wherein the profile of the user is associated with the digital platform. More particularly, the most relevant part of the product content is identified based on one or more object(s) and/or one or more attribute(s) identified for product content, wherein the one or more object(s) and/or the one or more attribute(s) are identified based on the user search query and/or the user profile. In cases where the attribute(s) and/or object(s) of interest cannot be extracted based on the user search query and/or the user profile, important object(s) for each product content and/or attribute(s) for each product type are selected from a pre-defined list of at least one of a set of objects and a set of attributes.

Also, the present invention provides a change in a user interface of a user device by adding rich and personalized content at least in a thumbnail view of a product content present on a search/browse page of a digital platform (such as an ecommerce platform).

Therefore, the present invention provides a novel solution of personalizing one or more product contents. Also the present invention provides a technical effect and technical advancement over the currently known solutions at least by providing a solution for personalizing a product content through product image/video enrichment using selective focus. Also, the present invention provides a technical advancement over the currently known solutions by providing an automatic detection of at least a most relevant part of a product content based on a user search query and/or user profile based features like browsing pattern etc. The present invention also provides a technical advancement over the currently known solutions by artificially generating a high-resolution version of an automatically detected most relevant part of an image/video and augmenting the image/video with it. Furthermore, the present invention also provides a technical advancement over the currently known solutions by enriching an information at least in a product thumbnail view present on a search and browse page of a digital platform.

Hereinafter, exemplary embodiments of the present disclosure will be described in detail with reference to the accompanying drawings so that those skilled in the art can easily carry out the present disclosure.

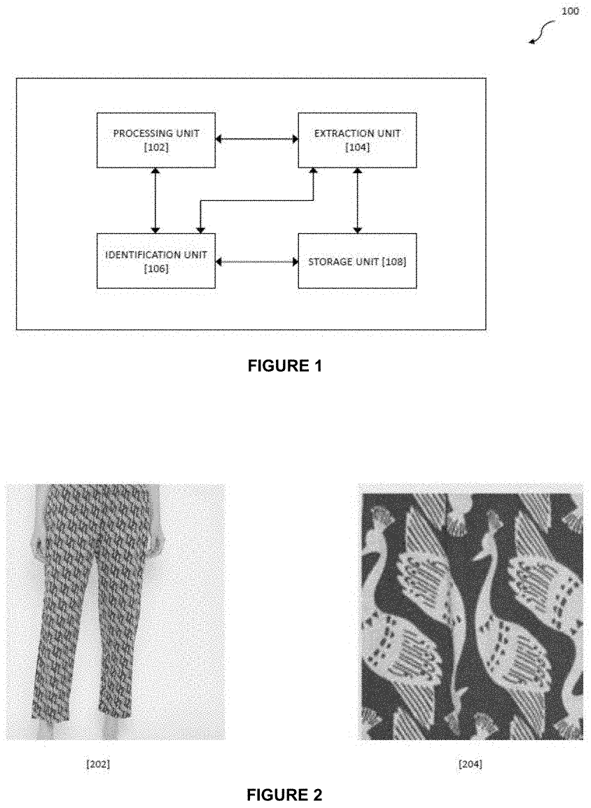

Referring to FIG. 1, an exemplary block diagram of a system [100] for personalizing one or more product contents is shown. The system [100] comprises at least one processing unit [102], at least one extraction unit [104], at least one identification unit [106] and at least one storage unit [108]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to personalize one or more product contents, with the help of the interconnection between the components/units of the system [100]. More particularly, on digital platforms such as e-commerce platforms, though search results shown are ranked according to their corresponding product search queries and/or user profiles, but product contents related to the search results (such as images/videos corresponding to the search results) are static and not personalized. In other words, there is personalization of the search results shown but the product contents shown for each searched product is the same for all users and is not modified based on any context. Therefore, at least to overcome this limitation, the system [100] is configured to personalize the one or more product contents, with the help of the interconnection between the components/units of the system [100].

The processing unit [102] of the system [100] is connected to the at least one extraction unit [104], at least one identification unit [106] and at least one storage unit [108]. The processing unit [102] is configured to detect, the one or more product contents on a digital platform in response to a product search query initiated by a user of the digital platform. The product search query is a user query initiated by the user to search a product on the digital platform. The user query may include a text command, a voice command or a combination thereof. Each product content from the one or more product contents is one of an image corresponding to a search result of the product search query and a video corresponding to the search result of the product search query. In an implementation each product content from the one or more product contents may be provided on a search and browse page of the digital platform in a thumbnail format, but the same is not limited thereto. Also, in a preferred implementation the digital platform is an e-commerce platform. In an example if a product search query to search a ‘Table’ is initiated by a user of an e-commerce platform, a search result related to the product ‘Table’ will be provided on a search and browse page of the e-commerce platform. The search result may further comprise one or more product contents such as one or more images corresponding the search result related to the product ‘Table’ and/or one or more videos corresponding to the search result related to the product ‘Table’. Also, in an instance, each image corresponding the search result related to the product ‘Table’ and/or each video corresponding to the search result related to the product ‘Table’ may be present in a thumbnail form. Further, in the given example the processing unit [102] is configured to detect, the one or more images/videos corresponding the search result related to the product ‘Table’ in response to the product search query initiated by the user to search the ‘Table’.

Thereafter, the processing unit [102] is configured to detect, at least one of one or more objects and one or more attributes for each of the one or more product contents. The at least one of the one or more objects and the one or more attributes are detected based on at least one of: the product search query, a user profile of the user, and a pre-defined list of at least one of a set of objects and a set of attributes. The user profile of the user is associated with the digital platform and the user profile is identified by the identification unit [106] based on an account (i.e. a user account associated with the digital platform) in which the user has initiated a search. More specifically, the identification unit [106] is configured to identify the user profile based on one or more identifiers associated with the user account, wherein the one or more identifiers may include but not limited to one or more email IDs, account holder names, contact details and the like information. For example, say the user has logged in to a user account associated with the digital platform based on the user's phone number. The user's profile, i.e., the history of the user's past search queries, past orders, etc. are associated with this account of the user's phone number. In an implementation, where the user has not logged in to a user account, a temporary user profile may be generated to detect features like browsing pattern, items added in cart, product marked as buy later, etc. to further identify at least one of the one or more objects and the one or more attributes for each of the one or more product contents. Also, such temporary user profile may be generated based on one or more parameters such as a device ID and/or an IP address etc. associated with the product search query. Furthermore, the one or more identifiers, a data associated with the user's profile, a data associated with the temporary user profile and the like details are stored at the storage unit [108] for implementation of the features of the present invention. Also, the access and the storage of the details associated with the users (such as the one or more identifiers, the data associated with the user's profile etc.) is based on a permission granted by the user. The storage unit [108] is also configured to store the pre-defined list of at least one of the set of objects and the set of attributes.

In an implementation, to detect at least one of the one or more objects and the one or more attributes for each of the one or more product contents, the processing unit [102] is configured to analyze the product search query. More specifically, the processing unit [102] is configured to extract the one or more objects and the one or more attributes of interest from the product search query using the techniques such as including but not limited to semantic query understanding, named entity recognition and the like. For example: If a user searches for ‘ethnic set with palazzo’ on an e-commerce platform, the processing unit [102] is configured to detect ‘palazzo’ as an object of interest for each image/video of each search result for ‘ethnic set with palazzo’. Also, in another example if a user searches for ‘ethnic set with printed kurta’ on an e-commerce platform, the processing unit [102] is configured to detect ‘kurta’ as an object of interest and ‘printed’ as an attribute for each image/video of each search result for ‘ethnic set with printed kurta’.

In another implementation, to detect at least one of the one or more objects and the one or more attributes for each of the one or more product contents, the processing unit [102] is configured to analyze the user profile associated with the product search query. More specifically, the processing unit [102] is configured to detect the one or more objects and the one or more attributes of interest based on user profile based features like browsing pattern, past purchases, items added in cart, product marked as buy later, etc. For example, if a user searches for ‘mobile’ on an e-commerce platform, the processing unit [102] is configured to search ‘camera’ as an object of interest for each image/video of each search result for ‘mobile’ based on a browsing pattern of the user indicating user is looking for a triple camera phone.

Further, in an implementation where the at least one of the one or more objects and the one or more attributes for each of the one or more product contents cannot be extracted, the processing unit [102] is configured to identify important object(s) and/or attribute(s) for each product content from the pre-defined list of at least one of the set of objects and the set of attributes. The pre-defined list of at least one of the set of objects and the set of attributes comprises at least one of one or more important objects for a plurality of product contents and one or more important attributes for the plurality of product contents. The pre-defined list of at least one of the set of objects and the set of attributes is generated based on at least one of a set of historical product search queries, a set of user profiles associated with the digital platform and a type of a set of products associated with the set of historical product search queries. Furthermore, FIG. 2 depicts an exemplary product content, in accordance with exemplary embodiments of the present invention. More specifically, FIG. 2 at [202] depicts a product content for which one or more attributes cannot be extracted as a pattern of the product content looks like a zig-zag pattern (due to aliasing), but is actually entirely different pattern. Further the FIG. 2 at [204] depicts the actual pattern. Therefore, in the given scenario the processing unit [102] is configured to identify the relevant pattern (attributes) for the product content depicted at [202] from the pre-defined list of at least one of the set of objects and the set of attributes.

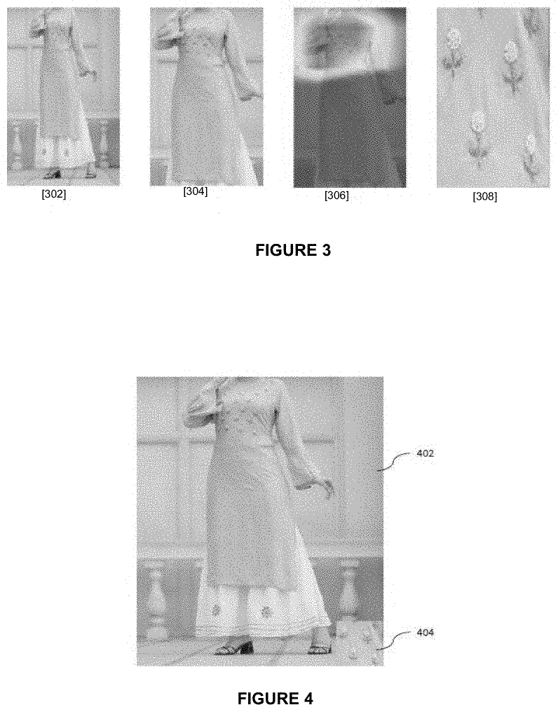

Once the at least one of the one or more objects and the one or more attributes are detected for each of the one or more product contents, an indication of the same is provided to the extraction unit [104], by the processing unit [102]. The extraction unit [104] comprises one or more units configured to extract a region of interest (i.e. a target portion) from each of the one or more product contents. More particularly, the extraction unit [104] is configured to extract, at least one target portion from each of the one or more product contents based on the at least one of the detected one or more objects and the detected one or more attributes, wherein the at least one target portion is the at least one region of interest. In an implementation, the extraction unit [104] is configured to extract the at least one target portion using one or more techniques such as including but not limited to a novel application of gradient based visualization methods like GRAD-CAM, where a coarse localization map produced using gradients of target attributes (for instance: say ‘pattern’ in a multi-task classification network) may be used to extract the at least one region of interest. FIG. 3 depicts an exemplary scenario for extraction of at least one target portion from a product content, in accordance with the exemplary embodiments of the present invention. More specifically, FIG. 3 at [302] depicts a product content detected in response to a product search query ‘printed kurta’. Further, the FIG. 3 at [304] depicts a first region of interest (i.e. a first target portion) extracted based on an object ‘kurta’ detected in the product search query. In an implementation, the extraction unit [104] is configured to extract the first target portion (i.e. kurta) using CNN based object localization and classification techniques. Further, the extraction unit [104] is also configured to extract a second region of interest (i.e. a second target portion) based on an attribute ‘printed’ detected in the product search query, using a multi-task learning based CNN architecture which is trained on a task of Image Attribute Extraction like pattern, neck-type etc. Thereafter, in an instance the extraction unit [104] is also configured to use GRAD-CAM based methods to compute a gradients of ‘pattern’ activation with respect to the product content depicted at [304] to compute a coarse localization map as shown at [306] in FIG. 3. More specifically, GRAD-CAM technique by computing the gradients of the attribute ‘pattern’ for object ‘kurta’ with respect to the product content generates a coarse localization map highlighting the parts of the product content that are important. Further, this localization map is used to select the second region of interest (i.e. second target portion) from which a final region of interest (final target portion) is extracted. Further, the FIG. 3 at [308] depicts the extracted final region of interest.

Also, in implementations where more than one target portions are identified by the extraction unit [104], an indication of the same is provided to the processing unit [102] by the extraction unit [104]. Thereafter, the processing unit [102] is configured to rank the identified target portions based on at least one of a prediction confidence score associated with each target portion from the identified target portions and the pre-defined list of at least one of the set of objects and the set of attributes. In an example, where the processing unit [102] is configured to rank the identified target portions based on the prediction confidence score, an identified target portion predicted with highest confidence will be ranked first followed by identified target portions with second highest confidence and so on. Also, in an example, where the processing unit [102] is configured to rank the identified target portions based on the pre-defined list of at least one of the set of objects and the set of attributes, an identified target portion associated with highest importance in the pre-defined list of at least one of the set of objects and the set of attributes will be ranked first followed by identified target portions with second highest importance and so on. Thereafter, the extraction unit [104] is configured to extract the at least one target portion based on the rank of the at least one target portion.

Further, once the at least one target portion is extracted from each of the one or more product contents, the processing unit [102] is then configured to generate, a high resolution variant of the at least one target portion. In an implementation the high resolution variant of the at least one target portion is generated using advanced un-sampling techniques. For example, advanced techniques like super-resolution to compute a high-resolution part of the at least one target portion are used as using techniques like super-resolution helps to avoid aliasing issues that can result from using simple interpolation schemes like bilinear interpolation etc.

Further, once the high resolution variant of the at least one target portion is generated, the processing unit [102] is configured to augment each of the one or more product contents with the corresponding at least one target portion to personalize the one or more product contents. More specifically, the processing unit [102] is configured to augment, each of the one or more product contents with the high resolution variant of the corresponding at least one target portion. FIG. 4 depicts an exemplary product content augmented with a high resolution variant of a corresponding target portion, in accordance with the exemplary embodiments of the present invention. More specifically, FIG. 4 at [402] depicts a product content as depicted at [302] in the FIG. 3. Once the final region of interest is extracted (as depicted in FIG. 3 at [308]), a high resolution variant of the same is generated based on the implementation of the features of the present invention. Thereafter, the product content [402] is augmented with the generated high resolution variant. More specifically FIG. 4 at [404] depicts the high resolution variant appended with the product content [402].

In an implementation, the identification unit [106] is also configured to identify, at least one target region on each of the one or more product contents based on a portion of one or more objects present in each of the one or more product contents. The at least one target region is at least one region on each of the one or more product contents where the at least one target portion can be attached without impacting the one or more objects present in each of the one or more product contents. More specifically, the at least one target region on each of the one or more product contents is identified such that the one or more objects present in each of the one or more product contents should not be impacted due to placement of the at least one target portion. Further in the given implementation to augment each of the one or more product contents with the corresponding at least one target portion, the processing unit [102] is further configured to append the at least one corresponding target portion with each of the one or more product contents based on the at least one target region identified on each of the one or more product contents. Furthermore, in an implementation, to augment each of the one or more product contents with the corresponding at least one target portion, the processing unit [102] is also configured to append with each of the one or more product contents the corresponding at least one target portion based on the ranking of said corresponding at least one target portion. More particularly, a target portion with a higher rank may be appended first as compared to a target portion with a lower rank in an event more than one target portions are extracted and more than one target portions can be appended with each of the one or more product contents (i.e. more than one target regions are identified). Also, if only one target portion can be appended with each of the one or more product contents, a target portion with the highest rank may be appended with each of the one or more product contents.

Also, to augment each of the one or more product contents with the corresponding at least one target portion, in an implementation the processing unit [102] is configured to extract a foreground object using techniques such as including but not limited to semantic segmentation/object detection, where a pixel level mask or a rectangular bounding box of the at least one target portion can be extracted and a background is enriched with a high-resolution crop of the product content generated based on the implementation of the features of the present invention, while using image blending techniques like averaging etc.

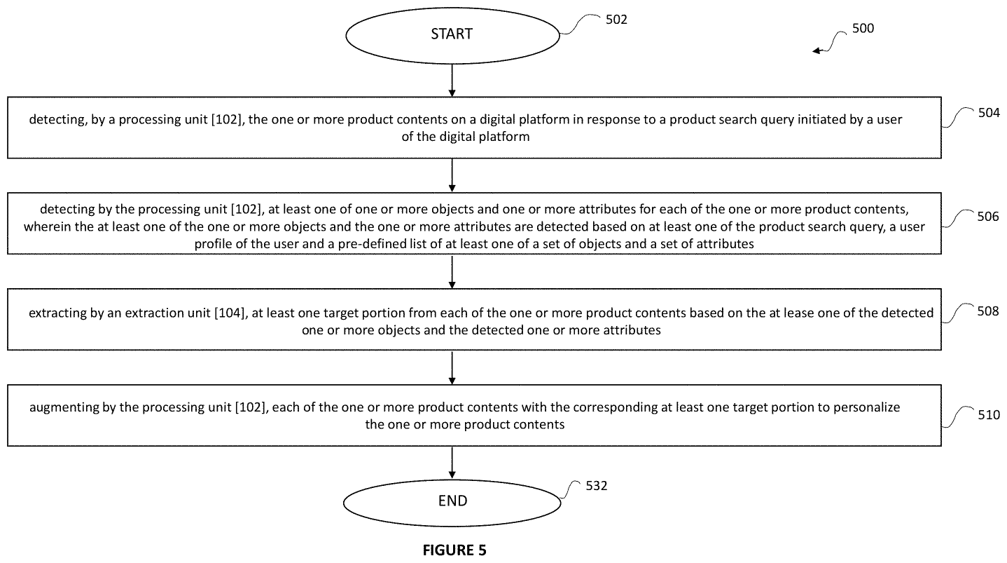

Referring to FIG. 5 an exemplary method flow diagram [500], for personalizing one or more product contents, in accordance with exemplary embodiments of the present disclosure is shown. In an implementation the method is performed by the system [100]. Further, in an implementation, the system [100] is connected to a server unit to implement the features of the present disclosure. Also, as shown in FIG. 5, the method starts at step [502].

At step [504] the method comprises detecting, by a processing unit [102], the one or more product contents on a digital platform in response to a product search query initiated by a user of the digital platform. The product search query is a user query initiated by the user to search a product on the digital platform. The user query may include a text command, a voice command or a combination thereof. Each product content from the one or more product contents is one of an image corresponding to a search result of the product search query and a video corresponding to the search result of the product search query. In an implementation each product content from the one or more product contents may be provided on a search and browse page of the digital platform in a thumbnail format, but the same is not limited thereto. Also, in a preferred implementation the digital platform is an e-commerce platform. In an example if a product search query to search a ‘Pen’ is initiated by a user of an e-commerce platform, a search result related to the product ‘Pen’ will be provided on a search and browse page of the e-commerce platform. The search result may further comprise one or more product contents such as one or more images corresponding the search result related to the product ‘Pen’ and/or one or more videos corresponding to the search result related to the product ‘Pen’. Also, in an instance, each image corresponding the search result related to the product ‘Pen’ and/or each video corresponding to the search result related to the product ‘Pen’ may be present in a thumbnail form. Further, in the given example, the method encompasses detecting by the processing unit [102], the one or more images/videos corresponding the search result related to the product ‘Pen’, in response to the product search query initiated by the user to search the product ‘Pen’.

Next at step [506] the method comprises detecting, by the processing unit [102], at least one of one or more objects and one or more attributes for each of the one or more product contents. The at least one of the one or more objects and the one or more attributes are detected based on at least one of: the product search query, a user profile of the user, and a pre-defined list of at least one of a set of objects and a set of attributes. The user profile of the user is associated with the digital platform and the method encompasses identifying the user profile by an identification unit [106] based on an account (i.e. a user account associated with the digital platform) in which the user has initiated a search. More specifically, the method comprises identifying by the identification unit [106], the user profile based on one or more identifiers associated with the user account, wherein the one or more identifiers may include but not limited to one or more email IDs, account holder names, contact details and the like information. In an implementation, where the user has not logged in to a user account, a temporary user profile may be generated to detect features like browsing pattern, items added in cart, product marked as buy later, etc. to further identify at least one of the one or more objects and the one or more attributes for each of the one or more product contents. Also, such temporary user profile may be generated based on one or more parameters such as a device ID and/or an IP address etc. associated with the product search query. Furthermore, the one or more identifiers, a data associated with the user's profile and the like details are stored at a storage unit [108] for implementation of the features of the present invention. Also, the access and the storage of the details associated with the users (such as the one or more identifiers, the data associated with the user's profile etc.) is based on a permission granted by the user. The method also encompasses storing at the storage unit [108], the pre-defined list of at least one of the set of objects and the set of attributes.

In an implementation, to detect at least one of the one or more objects and the one or more attributes for each of the one or more product contents, the method comprises analyzing by the processing unit [102], the product search query. More specifically, the method comprises extracting by the processing unit [102], the one or more objects and the one or more attributes of interest from the product search query using the techniques such as including but not limited to semantic query understanding, named entity recognition and the like. For example: If a user searches for ‘flagship smartphone’ on an e-commerce platform, the method encompasses detecting by the processing unit [102] ‘flagship smartphone’ as an object of interest for each image/video of each search result for ‘flagship smartphone’. Also, in another example if a user searches for ‘flagship smartphone with dual selfie camera’ on an e-commerce platform, the method encompasses detecting by the processing unit [102] ‘flagship smartphone’ as an object of interest and ‘dual selfie camera’ as an attribute for each image/video of each search result for ‘flagship smartphone with dual selfie camera’.

In another implementation, to detect at least one of the one or more objects and the one or more attributes for each of the one or more product contents, the method comprises analyzing by the processing unit [102], the user profile associated with the product search query. More specifically, the method comprises detecting by the processing unit [102], the one or more objects and the one or more attributes of interest based on user profile based features like browsing pattern, past purchases, items added in cart, product marked as buy later etc. For example, if a user searches for ‘laptop’ on an e-commerce platform, the method comprises searching by the processing unit [102], ‘Pen’ as an object of interest for each image/video of each search result for ‘laptop’ based on a browsing pattern of the user indicating user is looking for a Pen with a laptop.

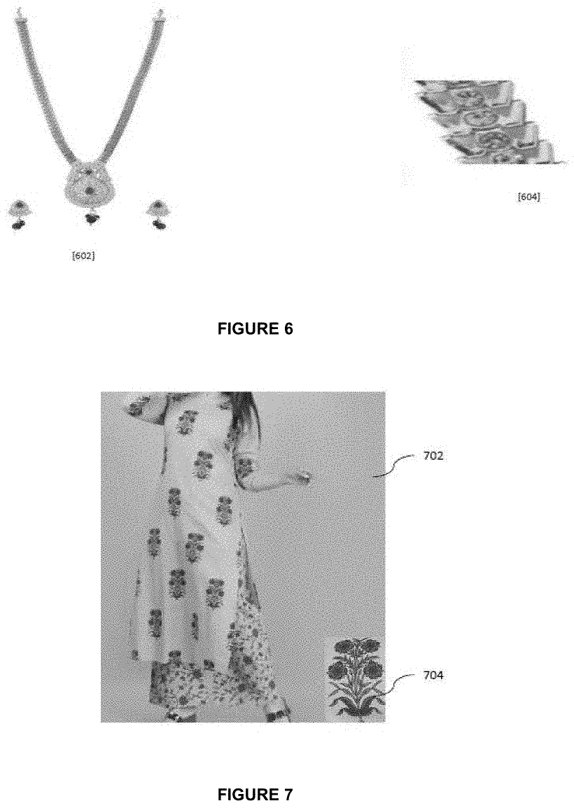

Further, in an implementation where the at least one of the one or more objects and the one or more attributes for each of the one or more product contents cannot be extracted, the method encompasses identifying by the processing unit [102] important object(s) and/or attribute(s) for each product content from the pre-defined list of at least one of the set of objects and the set of attributes. The pre-defined list of at least one of the set of objects and the set of attributes comprises at least one of one or more important objects for a plurality of product contents and one or more important attributes for the plurality of product contents. The pre-defined list of at least one of the set of objects and the set of attributes is generated based on at least one of a set of historical product search queries, a set of user profiles associated with the digital platform and a type of a set of products associated with the set of historical product search queries. Furthermore, FIG. 6 depicts an exemplary product content, in accordance with exemplary embodiments of the present invention. More specifically, FIG. 6 at [602] depicts a product content (i.e. an image of a necklace) for which one or more attributes (such as ‘detail’, ‘plating’, ‘finish’ etc.) cannot be extracted as the seller has not provided a zoomed/clearer image. Therefore, in the given scenario the method encompasses identifying by the processing unit [102], a relevant design (attribute) for the product content depicted at [602] from the pre-defined list of at least one of the set of objects and the set of attributes. The FIG. 6 at [604] depicts the relevant design of the product content.

Once the at least one of the one or more objects and the one or more attributes are detected for each of the one or more product contents, an indication of the same is provided to an extraction unit [104], by the processing unit [102]. Further, at step [508] the method comprises extracting, by the extraction unit [104], at least one target portion from each of the one or more product contents based on the at least one of the detected one or more objects and the detected one or more attributes, wherein the at least one target portion is at least one region of interest. In an implementation, the method comprises extracting, by the extraction unit [104], the at least one target portion using one or more techniques such as including but not limited to a novel application of gradient based visualization methods like GRAD-CAM, where a coarse localization map produced using gradients of target attributes (for instance: say ‘pattern’ in a multi-task classification network) may be used to extract the at least one region of interest.

Also, in implementations where more than one target portions are identified by the extraction unit [104], an indication of the same is provided to the processing unit [102] by the extraction unit [104]. Thereafter, the method encompasses ranking by the processing unit [102], the identified target portions based on at least one of a prediction confidence score associated with each target portion from the identified target portions and the pre-defined list of at least one of the set of objects and the set of attributes. In an example, where the method encompasses ranking by the processing unit [102], the identified target portions based on the prediction confidence score, an identified target portion predicted with highest confidence will be ranked first followed by identified target portions with second highest confidence and so on. Also, in an example, where the method encompasses ranking by the processing unit [102], the identified target portions based on the pre-defined list of at least one of the set of objects and the set of attributes, an identified target portion associated with highest importance in the pre-defined list of at least one of the set of objects and the set of attributes will be ranked first followed by identified target portions with second highest importance and so on. Thereafter, the method encompasses extracting by the extraction unit [104], the at least one target portion based on the rank of the at least one target portion.

Further, once the at least one target portion is extracted from each of the one or more product contents, the method encompasses generating by the processing unit [102], a high resolution variant of the at least one target portion. In an implementation the high resolution variant of the at least one target portion is generated using advanced un-sampling techniques. For example, advanced techniques like super-resolution to compute a high-resolution part of the at least one target portion are used as using techniques like super-resolution helps to avoid aliasing issues that can result from using simple interpolation schemes like bilinear interpolation etc.

Further, once the high resolution variant of the at least one target portion is generated, at step [510] the method comprises augmenting, by the processing unit [102], each of the one or more product contents with the corresponding at least one target portion to personalize the one or more product contents. More specifically, the method encompasses augmenting, by the processing unit [102], each of the one or more product contents with the high resolution variant of the corresponding at least one target portion. FIG. 7 depicts an exemplary product content augmented with a high resolution variant of a corresponding target portion, in accordance with the exemplary embodiments of the present invention. More specifically, FIG. 7 at [702] depicts a product content (i.e. an image corresponding to a search result of a product search query ‘ethnic set with printed kurta’). Once a region of interest (i.e. a target portion) is extracted based on the implementation of the features of the present invention, a high resolution variant of the same is generated. Thereafter, the product content [702] is augmented with the generated high resolution variant. More specifically FIG. 7 at [704] depicts the high resolution variant appended with the product content [702]. As the product content [702] is augmented with the high resolution variant of the target region, the user can clearly see the pattern of the kurta and can make an informed decision quickly.

In an implementation, the method also encompasses identifying by the identification unit [106], at least one target region on each of the one or more product contents based on a portion of one or more objects present in each of the one or more product contents. The at least one target region is at least one region on each of the one or more product contents where the at least one target portion can be attached without impacting the one or more objects present in each of the one or more product contents. More specifically, the at least one target region on each of the one or more product contents is identified such that the one or more objects present in each of the one or more product contents should not be impacted due to placement of the at least one target portion. Further in the given implementation, the process of augmenting, by the processing unit [102], each of the one or more product contents with the corresponding at least one target portion further comprises appending the at least one corresponding target portion with each of the one or more product contents based on the at least one target region identified on each of the one or more product contents. Furthermore, in an implementation, the process of augmenting, by the processing unit [102], each of the one or more product contents with the corresponding at least one target portion further comprises appending the corresponding at least one target portion with each of the one or more product contents based on the ranking of said corresponding at least one target portion. More particularly, a target portion with a higher rank may be appended first as compared to a target portion with a lower rank in an event more than one target portions are extracted and more than one target portions can be appended with each of the one or more product contents (i.e. more than one target regions are identified). Also, if only one target portion can be appended with each of the one or more product contents, a target portion with the highest rank may be appended with each of the one or more product contents.

Also, to augment each of the one or more product contents with the corresponding at least one target portion, in an implementation the method encompasses extracting by the processing unit [102] a foreground object using techniques such as including but not limited to semantic segmentation/object detection, where a pixel level mask or a rectangular bounding box of the at least one target portion can be extracted and a background is enriched with a high-resolution crop of the product content generated based on the implementation of the features of the present invention, while using image blending techniques like averaging etc.

After personalizing the one or more product contents, the method terminates at step [512].

Thus, the present invention provides a novel solution of personalizing one or more product contents. Also the present invention provides a technical effect and technical advancement over the currently known solutions at least by providing a solution for personalizing a product content through product image/video enrichment using selective focus. Also, the present invention provides a technical advancement over the currently known solutions by providing an automatic detection of at least a most relevant part of a product content based on a user search query and/or user profile-based features like browsing pattern etc. The present invention also provides a technical advancement over the currently known solutions by artificially generating a high-resolution version of an automatically detected most relevant part of an image/video and augmenting the image/video with it. Furthermore, the present invention also provides a technical advancement over the currently known solutions by enriching an information at least in a product thumbnail view present on a search and browse page of a digital platform.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for personalizing one or more product contents, the method comprising:
detecting, by a processing unit [102], the one or more product contents on a digital platform in response to a product search query initiated by a user of the digital platform;
detecting, by the processing unit [102], at least one of one or more objects and one or more attributes for each of the one or more product contents, wherein the at least one of the one or more objects and the one or more attributes are detected based on at least one of:
the product search query,
a user profile of the user, and
a pre-defined list of at least one of a set of objects and a set of attributes;
extracting, by an extraction unit [104], at least one target portion from each of the one or more product contents based on the at least one of the detected one or more objects and the detected one or more attributes; and
augmenting, by the processing unit [102], each of the one or more product contents with the corresponding at least one target portion to personalize the one or more product contents.

2. The method as claimed in claim 1, the method comprises identifying by an identification unit [106] the user profile based on a user account from which the product search query is initiated, wherein the user account is associated with the digital platform.

3. The method as claimed in claim 1, wherein the pre-defined list of at least one of the set of objects and the set of attributes is generated based on at least one of a set of historical product search queries, a set of user profiles associated with the digital platform and a type of a set of products associated with the set of historical product search queries.

4. The method as claimed in claim 1, the method further comprises ranking the at least one target portion based on at least one of a prediction confidence score associated with each target portion from the at least one target portion and the pre-defined list of at least one of the set of objects and the set of attributes.

5. The method as claimed in claim 4, wherein augmenting, by the processing unit [102], each of the one or more product contents with the corresponding at least one target portion further comprises appending the corresponding at least one target portion with each of the one or more product contents based on the ranking of said corresponding at least one target portion.

6. The method as claimed in claim 1, the method comprises:
generating by the processing unit [102], a high resolution variant of the at least one target portion, and
augmenting, by the processing unit [102], each of the one or more product contents with the high resolution variant of the corresponding at least one target portion.

7. The method as claimed in claim 1, the method further comprises identifying by the identification unit [106], at least one target region on each of the one or more product contents based on a portion of one or more objects present in each of the one or more product contents.

8. The method as claimed in claim 7, wherein augmenting, by the processing unit [102], each of the one or more product contents with the corresponding at least one target portion further comprises appending the at least one corresponding target portion with each of the one or more product contents based on the at least one target region identified on each of the one or more product contents.

9. A system for personalizing one or more product contents, the system comprising:
a processing unit [102], configured to:
detect, the one or more product contents on a digital platform in response to a product search query initiated by a user of the digital platform, and
detect, at least one of one or more objects and one or more attributes for each of the one or more product contents, wherein the at least one of the one or more objects and the one or more attributes are detected based on at least one of:
the product search query,
a user profile of the user, and
a pre-defined list of at least one of a set of objects and a set of attributes; and
an extraction unit [104], configured to extract, at least one target portion from each of the one or more product contents based on the at least one of the detected one or more objects and the detected one or more attributes, wherein:
the processing unit [102] is further configured to augment each of the one or more product contents with the corresponding at least one target portion to personalize the one or more product contents.

10. The system as claimed in claim 9, the system further comprises an identification unit configured to identify the user profile based on a user account from which the product search query is initiated, wherein the user account is associated with the digital platform.

11. The system as claimed in claim 9, wherein the pre-defined list of at least one of the set of objects and the set of attributes is generated based on at least one of a set of historical product search queries, a set of user profiles associated with the digital platform and a type of a set of products associated with the set of historical product search queries.

12. The system as claimed in claim 9, wherein the processing unit [102] is further configured to rank the at least one target portion based on at least one of a prediction confidence score associated with each target portion from the at least one target portion and the pre-defined list of at least one of the set of objects and the set of attributes.

13. The system as claimed in claim 12, wherein to augment each of the one or more product contents with the corresponding at least one target portion, the processing unit [102] is further configured to append with each of the one or more product contents the corresponding at least one target portion based on the ranking of said corresponding at least one target portion.

14. The system as claimed in claim 9, wherein the processing unit [102] is further configured to:
generate, a high resolution variant of the at least one target portion, and
augment, each of the one or more product contents with the high resolution variant of the corresponding at least one target portion.

15. The system as claimed in claim 9, wherein the identification unit [106] is further configured to identify, at least one target region on each of the one or more product contents based on a portion of one or more objects present in each of the one or more product contents.

16. The system as claimed in claim 15, wherein to augment each of the one or more product contents with the corresponding at least one target portion, the processing unit [102] is further configured to append the at least one corresponding target portion with each of the one or more product contents based on the at least one target region identified on each of the one or more product contents.
